(19) United States
(12) Patent Application Publication
(10) Pub. No.: US 2005/0062282 A1
(43) Pub. Date: Mar. 24, 2005

(54) Coupling for the connection of ducts

(75) Inventors: Thomas Rosch, Lisengericht (DE); Andreas Seyler, Grundau (DE); Jan Osthold, Langgons (DE); Wilfried Zulch, Gelnhausen (DE); Artur Poppel, Gelnhausen (DE)

Correspondence Address: BURNS DOANE SWECKER & MATHIS L L P, POST OFFICE BOX 1404, ALEXANDRIA, VA, 22313-1404, US

(73) Assignee: VERITAS AG, Gelnhausen (DE)

(21) Appl. No.: 10/892,139

(22) Filed: Jul. 16, 2004

(30) Foreign Application Priority Data
Aug. 8, 2003 (DE) 103 36 494.3

(51) Int. Cl. F16L 13/00

(52) U.S. Cl. 285/21.1; 285/285.1; 285/22

(57) ABSTRACT

In order to effect an impervious and, at the same time, stable connection of fluid-conducting ducts, especially of hoses or pipes, a coupling having a connector is provided in accordance with the invention, which cooperates with a duct at least portion-wise, with the connector comprising at least one adhesive space which is filled with an adhesive. According to the method of connecting ducts a coupling according to the invention is used, whereby the connector of the coupling is, for instance, mounted on a duct and a thermal treatment is carried out, during which both the adhesive is hardened and the duct is thermally deformed.

The invention relates to a coupling for the connection of ducts, especially of hoses or pipes, comprising a connector which cooperates with a duct at least portion-wise.

Couplings of this type are typically used in the automobile industry, when fluid-conducting ducts, e.g. fuel hoses, are connected. Such couplings are also known as in-line quick couplings or so-called quick connectors. In order to guarantee a firm seat of the duct on the connector, i.e. the connection piece or fitting of the coupling, the fluid-conducting duct is fabricated with an inside diameter smaller than the outer diameter of the connection piece and is pressed onto the same. The most widely used connection type in this technology is the drive-in connection with a positive locking being produced between the connection piece and the duct. The connector is thereby provided with a corresponding profile, e.g. with annular toothed undercuts. This profiled connector is pressed into a duct having a smaller dimensioned diameter, so that the inside wall of the duct is plastically and elastically deformed, with a simultaneous sealing and a firm seat being achieved. Such a connection is also called christmastree connection. As profiling of the connector also rounded-off beads are used, which form a compromise between retaining and sealing at higher temperatures.

A problem encountered with these known couplings resides in the tendency of the polymeric materials used in the fabrication of ducts and axially orientated in the extrusion process to the relaxation at increased temperatures, whereby the retention force and the imperviousness gets lost at least partially.

For avoiding this problem, one has turned to welding or soldering the fluid-conducting duct and the connector with each other. Due to the material-fit connection no permanent driving tension between the duct and the connector is necessary for producing a sufficient imperviousness and/or retention force, with the result that a sufficient connection is maintained also at higher temperatures.

The welding not only has the drawback that special ducts are required, but also that the material selection is strongly limited. A free material selection is impossible due to the missing miscibility of the molten plastic mass, which results from the different constitution and polarity of different plastics materials. Therefore, the appropriate counter-piece has to be provided for each duct or connection piece material. For example, plastic pipes cannot be welded with metallic connection pieces.

The welding may specifically be accomplished by means of laser welding. To this end, special ducts are required, which are transparent for the laser light in the connection area. If the duct is mounted, the laser beam can thus be focused onto the surface of the connection piece, and sufficient thermal energy may be introduced in the surface thereof so as to effect sufficient heating for the welding.

The connections produced by laser welding are moreover very expensive due to the high investment expenses.

Therefore, the invention is based on the object to provide a coupling for the connection of ducts, which is easy and inexpensive to fabricate and which simultaneously has good sealing and/or retention properties. Moreover, a method of connecting ducts is to be provided, which is performable by means of the coupling according to the invention.

In view of the coupling, the object is provided by the subject matter according to claim 1. In view of the method, the aforementioned object is provided by the subject matter according to claim 20.

The advantage of the invention resides in that it is avoided due to the adhesive space provided in the connector that, when the duct is mounted on the connector, the adhesive is scraped off from the connector by the front face of the duct. By means of the adhesive space it is achieved that a relatively large amount of adhesive is provided on a predetermined location, which can at least substantially not be reached by the front face of the duct when the duct is mounted on the connector. Therefore, sufficient adhesive is provided on certain predefined locations of the connector guaranteeing a secure connection of the ducts with the connector of the coupling.

Furthermore, the adhesive not only provides for an adhesive connection between the duct and the connector after it has hardened, but also for a good mechanical connection, which prevents the duct from getting out of place, namely due to the three-dimensional adhesive space filled out by the hardened adhesive.

The coupling according to the invention therefore provides in a surprisingly simple manner a very inexpensive solution, which allows—as compared to known couplings constructed in accordance with the principle of the drive-in connection—an increase of the operating temperatures and operating pressures, without losing the imperviousness or the retention force of the coupling. The drawbacks resulting from the relaxation of polymers at high temperatures are suppressed by the use of the adhesive.

The coupling according to the invention moreover allows a nearly optional combination of mated materials between the coupling and the duct, which substantially only has to take into account the adhesive capacity of the adhesive as used. Moreover, the coupling according to the invention does not underlie any limitations with respect to the material compatibility or laser transparence. Due to the large contact surfaces the coupling has a high mechanical loading capacity.

According to a preferred embodiment the adhesive space comprises at least one recess in a connecting surface of the connector. This one or, if necessary, these several recesses many be filled with an adhesive in a simple manner and thus form a three-dimensional accommodation space for the adhesive, which is a suitable reservoir for the adhesive after the duct has been mounted on the coupling. According to this construction of the coupling the mechanical connection between the duct and the coupling particularly takes effect after the adhesive has hardened, since the hardened adhesive fills out the recess or the recesses in the connecting surface of the connector in a sealing manner, on the one hand, and since it is adhesively connected with the duct, on the other hand.

It has proved to be useful if the recess is formed as a notch, which constitutes a particularly simple realization of the adhesive space.

The recess may be planar, preferably with a circular or oval circumference. This provides the advantage of an enlarged adhesion surface, which again is in favor of the stability of the connection.

The recess may also be formed as a groove, preferably with a U- or V-shaped or rectangular cross-section. By this it is achieved that the adhesive space extends over a longer portion of the connector, so that a leakage-preventing barrier is built up between the duct and the connector.

The groove is preferably, at least partially, provided in the circumferential direction and/or in the longitudinal direction of the connector.

The arrangement of the groove in a circumferential direction is particularly advantageous if a medium is to be transported under a higher pressure, as the imperviousness of the coupling is improved by this arrangement of the groove.

In certain cases of application of the coupling it is important that the duct mounted on the connector of the coupling is secured against twisting, i.e. against a displacement in the circumferential direction. For such applications it is useful to provide the groove in a longitudinal or, respectively, axial direction of the connector. The adhesive hardened in the groove then acts like a feather key so that the mechanical stability of the connection is increased. According to this embodiment the main emphasis is formed by a good retaining function of the coupling.

By a groove, which extends in both the circumferential and the longitudinal direction of the connector, both the imperviousness and the torsional strength of the connection can be improved.

According to another preferred embodiment of the inventive coupling the connector comprises at least two elevations spaced away from each other, which surround the connector in the circumferential direction at least partially, with the adhesive space being formed between these elevations. The advantage of this embodiment resides in that the adhesive connection is combined with a form-fit connection. By the elevations provided in the effective portion of the connector a profiling of the connector is achieved, which allows a form-fit connection with a duct mounted on the connector. At the same time, the interspace formed between the elevations serves as an adhesive space filled with adhesive. The surface of the adhesive located in this adhesive space contacts the inside of the duct mounted on the connector so that an adhesive connection between the connector and duct is produced in addition to the form-fit connection effected by the elevations. This coupling therefore unites the advantages of a mechanical form-fit connection with the advantages of an adhesive connection.

It is useful if the elevations are toothed. These toothed elevations dig themselves into the inside of the duct thereby forming a particularly good form-fit connection. If the rear tooth flank in the connecting direction is inclined more steeply than the front tooth flank, the duct is easier to slip on whereby, at the same time, a particularly strong resistance against pulling off the duct from the connector is ensured by the more steeply inclined rear flank. According to another embodiment the elevations may be wave-shaped.

According to a particularly preferred embodiment the adhesive space is formed to receive an end portion of the duct, with the adhesive space being provided in a rear portion of the connector in the connecting direction and being opened opposite to the connecting direction. According to this embodiment the duct end on the side of the coupling is inserted into the adhesive space formed as an accommodation space, where it is pasted together with the adhesive filled into the adhesive space. Since the entire duct end is thereby embedded in the adhesive and, at the same time, the interspaces between the duct end and the inside wall of the adhesive space are uniformly filled with adhesive while the duct end is pushed in, this embodiment is particularly advantageous in view of the imperviousness.

In a particularly advantageous manner several adhesive spaces spaced away from each other are provided, each of which have the same shape or different shapes. By combining several adhesive spaces, e.g. by the combination of the adhesive space formed as an accommodation space in the rear portion of the connector with the recesses provided in the connecting surface, a connection between the duct and connector can be produced, which is characterized by a specifically good imperviousness and a specifically good stability.

The connector may be adapted so as to cooperate with an inner surface of the duct, with the adhesive space being provided in an outer surface of the connector. The connector may alternatively be adapted to cooperate with an outer surface of the duct, with the adhesive space being provided in an inner surface of the connector. Thus, the duct is either slipped onto the connector or pushed into the connector.

With a connector adapted to be pushed into a duct a diameter defining the inner surface of the connector may be larger than an outer diameter of the duct, so that a gap is formed between the inner surface of the connector and the outer surface of the duct, which may be filled with adhesive.

In addition, the connector may comprise a projection forming, with the inner surface, an accommodating gap for an end portion of the duct, by means of which a positioning of the duct in the connector is achieved. Moreover, this accommodating gap may be filled with adhesive.

It has proved to be useful if the projection has length of 1 mm to 50 mm.

Preferably, a wall is provided between the inner surface and the projection of the connector, in which a recess for accommodating adhesive is formed. When the duct end is pushed in, the adhesive runs into this recess. The adhesive run into the recess, where it hardens, improves the imperviousness of the connection.

Additional embodiments of the coupling according to the invention are described in the sub-claims.

The advantage of the method according to the invention resides in that, by the simultaneous hardening of the adhesive as well as by the thermal shaping of the duct material, two process steps are performed by one single thermal treatment, so that the method is shortened and costs are reduced. In addition, the method is easy to automate.

The invention will hereinafter be explained in more detail with reference to the attached schematic drawings, wherein

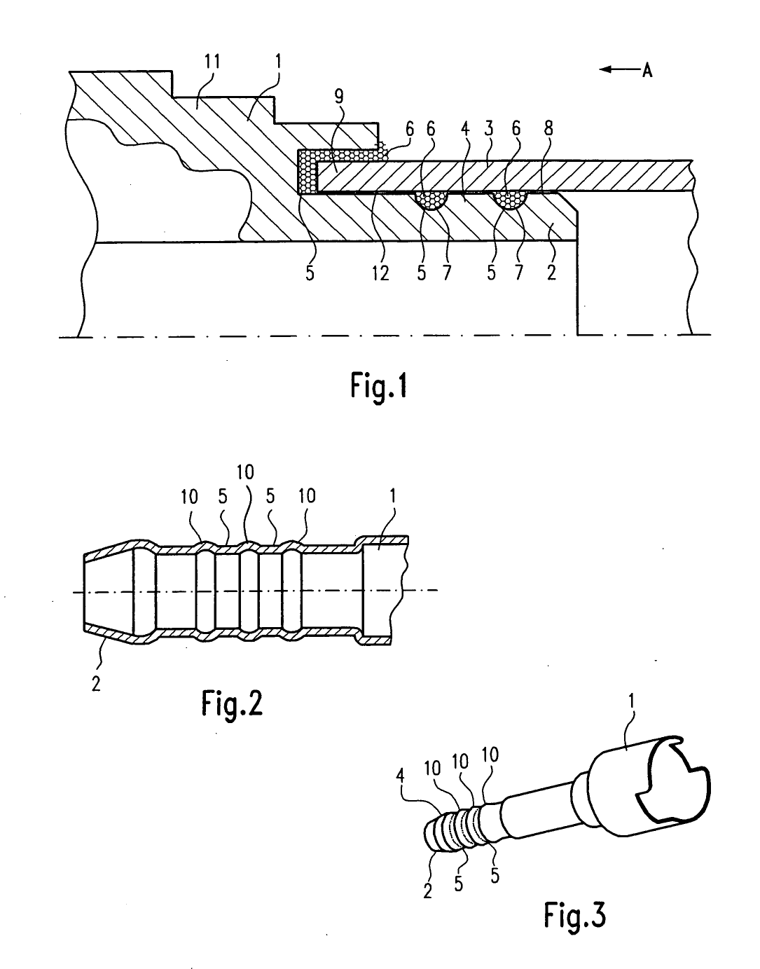

FIG. 1 shows a longitudinal section through a coupling according to an embodiment of the invention on which a duct is mounted;

FIG. 2 shows a longitudinal section through the connector of a coupling according to another embodiment, with the connector having a wave-shaped profile;

FIG. 3 shows a schematic, perspective view of the coupling according to FIG. 2, and

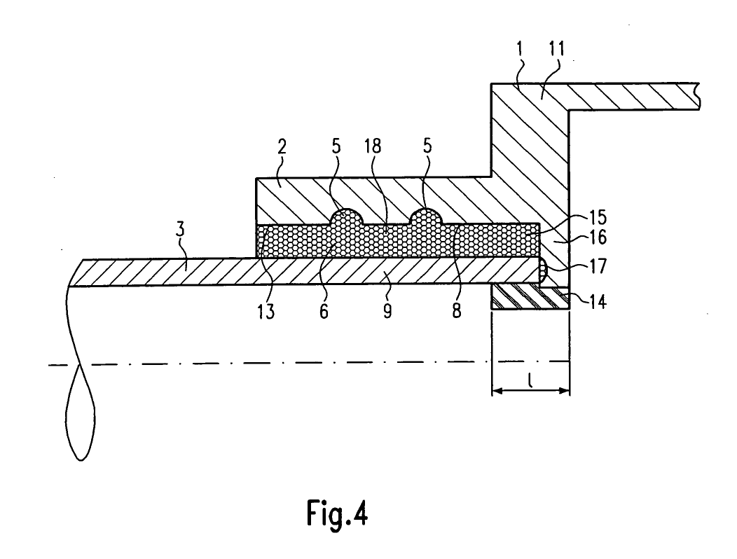

FIG. 4 shows a longitudinal section through a coupling according to another embodiment in which a duct is inserted.

FIG. 1 shows, in a longitudinal section, a coupling for connecting ducts, whereby the illustration of the lower part of the rotationally symmetrical coupling has been waived, as the same corresponds to the part as shown.

The coupling 1 comprises a housing 11 to which connecting components, e.g. the feed inlet to a fuel tank, may be connected. The stepped design of the housing as shown is only an example and may be replaced by other housing shapes. The housing 11 of the coupling 1 is integrally connected to a connector 2, which extends along the symmetrical axis of the coupling. The connector 2 has an effective portion 4 in which the connector cooperates with a mounted duct 3. The duct 3 is pushed or pressed onto the connector 2 so as to produce a mechanical connection between the duct 3 and the connector 2. In the example as shown, the connector 2, especially the effective portion 4 of the connector 2, is tubular. Other cross-sectional shapes of the effective portion 4 of the connector 2 are equally possible in dependence on the case of application.

As can further be recognized in FIG. 1, adhesive spaces 5 are provided in the effective portion 4 of the connector 2, especially in the contact surface, i.e. the connecting surface 8. These adhesive spaces are filled with adhesives 6, which are brought into an adhesive contact with the duct 3 mounted on the connector 2. By this, an adhesive connection between the duct 3 and the effective portion 4 of the connector is produced.

The shape, the arrangement and the number of adhesive spaces 5 are not limited to the example shown in FIG. 1 with two adhesive spaces 5 in the connecting surface 8. Any other number of adhesive spaces 5, e.g. 3 to 20 adhesive spaces, is possible, whereby the indicated range from 3 to 20 covers each intermediate value, i.e. for example also 5, 10 or 15 adhesive spaces 5.

Also, another arrangement of the adhesive spaces 5, e.g. differently spaced apart adhesive spaces 5 is possible. The adhesive spaces 5 provided in the connecting surface 8 may have any optional form of a recess 7, e.g. that of a notch. Recesses 7 having a larger contact surface, e.g. circular or oval recesses 7, are likewise conceivable. Another possible design is the formation of the recesses 7 as a groove extending either partially or entirely in the circumferential direction of the connector 2. The arrangement of one or several grooves 7 in the longitudinal direction of the connector 2, or a combination of circumferential grooves and longitudinal grooves, is possible as well.

The coupling 1 shown in FIG. 1 has another shape of the adhesive space 5, which his not formed in the connecting surface 8, but is provided at the rear end of the connector 2 in the connecting direction.

In FIG. 1 the connecting direction is indicated with arrow A.

As can be seen in FIG. 1, the adhesive space 5 formed as an accommodating portion for a duct end 9 is limited by the connecting surface 8 and two inner surfaces of the housing 11. The connecting surface 8 and the two inner surfaces of the housing 11 form a recess with a U-shaped cross-section, which is opened opposite to the connecting direction A. The so limited adhesive space 5 is filled with an adhesive 6, which is uniformly pressed in by pushing in the duct end 9 between the gap between the duct end 9 and the U-shaped recess. Thus, a particularly impervious connection between the coupling 1 and the duct 3 is obtained.

In the embodiment shown in FIG. 1 a connection is produced between the duct 3 and the coupling 1 by pasting the duct end 9 together with the accommodating portion of the connector 2 and by forming defined adhesion spots in the connecting surface 8 of the connector 2, which connection has a sufficient imperviousness as well as a sufficient stability. Basically it is also perceivable to form the recess not in a U-shaped, but a V-shaped manner. Alternatively, also the outer inner surface of the housing could be formed conically. It must be ensured, however, that the recess is pocket-shaped.

Another example of an inventive coupling is illustrated in FIG. 2. It can be seen that a wave-shaped profiling is provided in the effective portion 4 of the connector 2, by means of which a positive fit between the connector 2 and a duct mountable on the connector can be produced. The interspaces between two elevations 10 spaced away from each other define adhesive spaces 5 which are filled with an adhesive 6. Due to the wave-shaped profiling of the connector 2, both a form-fit connection and an adhesive connection are produced between the duct and the connector 2, which is obtained by the interspaces filled with adhesives or, respectively, by the adhesive spaces 5. A coupling 1 of this type is therefore characterized by a particularly good imperviousness as well as by a particularly high stability of the connection so that this coupling 1 may also be exposed to stronger loads. The coupling 1 shown in FIG. 2 is once more illustrated in FIG. 3 in a perspective view.

FIG. 4 shows another example of a coupling according to the invention, with the connecting surface 8 being formed as an inner surface 13 of the connector 2. Accordingly, the end portion 9 of the duct 3 is inserted into the connector 2 of the coupling 1, with the outer diameter of the end portion 9 being smaller than the inner diameter of the connector 2. The inner shape of the connector 2 is thereby in accordance with the design of the duct 3 and is, in general, cylindrical. Other designs, e.g. an oval or angular inner shape of the connector 2, are conceivable. This also refers to the other aforementioned examples, where the connecting surface 8 is formed as outer surface of the connector 2.

As can further be seen in FIG. 4, two adhesive spaces 5 are provided in the inner surface 13 which, in the present example, are formed as peripheral grooves having a U-shaped cross-section. Another number of grooves, for instance, only one groove or multiple grooves, e.g. three or four grooves, is likewise possible. The grooves need not be peripheral perpendicularly to the longitudinal axis of the coupling 1, but may also be formed, entirely or only partially, peripherally in different ways, e.g. in a screw-shaped way. Grooves extending axially, i.e. in the longitudinal direction of the coupling 1, or a combination of axial and radial grooves are likewise possible.

In the embodiment shown in FIG. 4 the inner diameter of the connector 2 defining the inner surface 13 is larger than the outer diameter of the duct 3 in the area of the end portion 9. By this, a gap 18 is formed between the outer surface of the duct 3 and the inner surface 13 of the connector 2, which is filled with adhesive 6. By this, a particularly good adhesive connection between the duct 3 and the coupling 1 is produced in the portion of the connector 2. Another selection of the two diameters is conceivable. Both diameters may, for example, be selected such that a press fit is formed between the duct 3 and the connector 2, with the mechanical connection so formed being supported by the adhesive connection produced by the adhesives 6 provided in the adhesive spaces 5.

For positioning the end portion 9 of the duct 3 in the area of the connector 2 of the coupling 1 a projection 14 is provided, which—in the present example—closes the housing wall 16 extending perpendicularly to the longitudinal direction of the coupling 1 concentrically to the inner surface 13 on the front side. By this, an accommodating gap 15 is formed between the projection 14 and the inner surface 13 into which the end portion 9 of the duct 3 is inserted. FIG. 4 shows that this accommodating gap 15 is wide enough to not only accommodate the end portion 9 therein, but also a corresponding amount of adhesive 6. It is not necessary that the projection 14 is formed as a cylinder concentric to the inner surface 13. Other shapes of the projection 14, e.g. several webs projecting into the inner space of the connector 2, are likewise possible, provided that the end portion 9 of the duct 3 introduced into the connector 2 can be positioned thereby. The projection 14 can, moreover, be formed integrally with the housing 11 of the coupling 1. A two-piece shape is also possible, whereby the projection 14 is connected to the wall 16 of the housing 11 as a separate component.

The length L of the projection 14 may range between 1 mm and 50 mm, whereby even shorter or even longer projections are also possible. It is self-evident that all intermediate values, e.g. 15, 20, 30 or 35 mm, are disclosed together with these indicated ranges.

Moreover, it can be seen in FIG. 4 that in the wall 16 of the housing 11 provided between the inner surface 13 and the projection 14 a recess 17 is provided. This recess 17 is adjacent the projection 14 so that a front face of the end portion 9 of the duct 3 closes the recess 17 in the inserted state. In dependence on the wall strength of the duct 3 the recess 17 may also be arranged farther away from the projection 14. When the end portion 9 is inserted, adhesive is collected in front of the front face, which is pressed into the recess 17 by the insertion. By this, the recess 17 is filled with adhesive 6 so that an adhesive connection between the front face of the end portion 9 and the wall 16 of the housing 11 is formed in the hardened state of the adhesive 6. This contributes to a further improvement of the imperviousness of the connection between the duct 3 and the coupling 1. The cross-sectional recess 17 shown in FIG. 4 runs concentrically to the inner surface 13 in the wall 16 about the longitudinal axis of the coupling 1.

For producing the connection between the coupling 1 and the duct 3, a single-layered or multilayered pipe or, respectively, a single-layered or multilayered hose is extruded from a plastics material, e.g. by thermal deformation. The adhesive is applied onto the coupling made of metal or likewise of plastics material, whereby the adhesive spaces 5 are filled with adhesives. The coupling is then mounted on the pipe, whereby the pipe with the coupling is placed in a mold in which the desired shaping takes place. With the coupling the pipe is then transferred, e.g. into a treatment chamber in which a thermal treatment is performed. Due to the thermal treatment the adhesive hardens as a result of curing and/or polymerization, so that a stable connection between the pipe and the coupling is produced. At the same time, a shaping in correspondence with the insertion mold is obtained as a result of the thermal treatment.

Thus, a complete operating cycle with several operating steps is saved, which renders this method particularly inexpensive.

In another example a pipe fabricated of polyamide may be connected with a coupling made of polyamide by using a polyamide paste or polyamide solution as adhesive. Instead of the polyamide also other materials may be used, e.g. polyethylene. During the activation in a chemical/physical manner the polymerization or, respectively, the curing is started in the paste or the solution, whereby a stable connection between the pipe and the coupling is formed, e.g. by the formation of macromolecular structures from the monomer structures.

Another connection possibility is accomplished by means of hot-melt adhesives, PUR, epoxy resin or a plastic composite. The hot-melt adhesives are reversibly melted on and applied, whereby the hardening is effected by cooling. The plastic composites consist of a plastic matrix and fillers on an organic or inorganic basis.

As materials for the coupling all possible metals, including the alloys thereof, come into question, whereby the metals may—in correspondence with their application—be quenched and tempered or, in general, heat-treated. Moreover, plastics materials such as thermoplastics, duroplasts, thermosetting materials, elastomers, thermoplastic elastomers, ceramics, sintered materials and glass may be used. A composite from these materials is also conceivable. The surfaces especially of the connector 2 may be untreated, treated or coated.

As regards the material for the duct, also the materials mentioned in conjunction with the coupling come into question. All possible material combinations between the coupling and the duct are thereby conceivable.

Moreover, single-layered or multilayerd ducts may be used. The design of the ducts is likewise not limited. Thus, the ducts may be designed as plain ended pipe or as corrugated pipe, which may also be corrugated only section-wise or in parallel or spirally. A plasma surface treatment of the plastics materials, a surface metallization or the treatment with a primer are likewise perceivable.

As adhesives single-component or multi-component adhesives, thermosetting adhesives (e.g. epoxy resin, PUR polyurethane, polyester adhesives), moreover solvent-free or solvent-containing adhesives, hot-melt adhesives and pure or filled adhesives can be applied. As fillers or effective or functional substances in the adhesives plastic particles, inorganic and organic components as well as carbon, chalk or soot are possible. When carbon is used, the electrical conductivity of this material must, of course, be considered.

Hardenable adhesives should be hardened at temperatures between −50° C. and +350° C.

The adhesives may be activated by thermal influence, but also by other forms of energy, e.g. by electromagnetic radiation, especially in the UV, infrared or microwave range. The activation of adhesives may be accomplished by chemical/physical reactions, e.g. by an activator supplied into the treatment chamber as gas. The activation of the adhesives by means of moisture is also perceivable, which entails the advantage that the reaction may take place in a normal atmosphere.

The coupling is suited particularly for use in the automobile industry, e.g. for the connection of fluid ducts such as fuel hoses, but also for use in other technical fields in which the creation of impervious and stable connections between ducts, through which liquid media are passed, is significant.

1. A coupling for connecting ducts, especially hoses or pipes, having a connector cooperating at least portion-wise with a duct,
wherein
the connector comprises at least one adhesive space filled with an adhesive.

2. A coupling according to claim 1, wherein the adhesive space comprises at least one recess in a connecting surface of the connector.

3. A coupling according to claim 2, wherein the recess is formed as a notch.

4. A coupling according to claim 2, wherein the recess is planar, preferably with a circular or oval circumference.

5. A coupling according to claim 2, wherein that recess is formed as a groove.

6. A coupling according to claim 5, wherein the groove is at least partially provided in the circumferential and/or longitudinal direction of the connector.

7. A coupling according to claim 1, wherein the connector comprises at least two elevations spaced away from each other surrounding the connector at least partially in the circumferential direction, whereby the adhesive space is formed between the elevations.

8. A coupling according to claim 7, wherein the elevations are tooth-shaped, whereby the rear tooth flank in the connecting direction is preferably inclined more steeply than the front tooth flank.

9. A coupling according to claim 7, wherein the elevations are wave-shaped.

10. A coupling according to claim 1, wherein the adhesive space is formed to accommodate an end portion of the duct, whereby the adhesive space is provided in a rear portion of the connector in the connecting direction and is opened opposite to the connecting direction.

11. A coupling according to claim 1, wherein several adhesive spaces spaced away from each other are provided each of which have the same shape or different shapes.

12. A coupling according to claim 1, wherein the coupling is made of metal, plastics, ceramics, a sintered material, glass or a composite of two or more of these materials.

13. A coupling according to claim 1, wherein the adhesive comprises single- or multi-component adhesives, thermosetting adhesives, solvent-free or solvent-containing adhesives, hot-melt adhesives and pure or filled adhesives.

14. A coupling according to claim 1, wherein the coupling is adapted to cooperate with an inner surface of the duct, whereby the adhesive space is provided in an outer surface of the connector.

15. A coupling according to claim 1, wherein the connector is adapted to cooperate with an outer surface of the duct, whereby the adhesive space is provided in an inner surface of the connector.

16. A coupling according to claim 15, wherein a diameter defining the inner surface is larger than an outer diameter of the duct.

17. A coupling according to claim 15, wherein the connector has a projection forming with the inner surface an accommodating gap provided for an end portion of the duct.

18. A coupling according to claim 17, wherein the projection has a length from 1 mm to 50 mm.

19. A coupling according to claim 17, wherein a wall is provided between the inner surface and the projection of the connector, in which a recess for accommodating adhesives is formed.

20. Method of connecting ducts, especially hoses or pipes, by means of a coupling according to at claim 1, wherein
the connector of the coupling is mounted on a duct and
a thermal treatment is carried out, during which both the adhesive is hardened and the duct is thermally deformed.
